(19) United States
(12) Patent Application Publication
(10) Pub. No.: US 2007/0188919 A1
(43) Pub. Date: Aug. 16, 2007

(54) THIN-FILM MAGNETIC HEAD HAVING CONTROLLED LEVITATION AMOUNT BY LOCALLY PROJECTING AN ELEMENT PORTION TOWARD RECORDING MEDIUM USING THERMAL EXPANSION

(75) Inventor: Kiyoshi Kobayashi, Niigaka-ken (JP)

Correspondence Address: BRINKS HOFER GILSON & LIONE, P.O. BOX 10395, CHICAGO, IL, 60610, US

(73) Assignee: ALPS ELECTRIC CO., LTD., Tokyo (JP)

(21) Appl. No.: 11/674,873

(22) Filed: Feb. 14, 2007

(30) Foreign Application Priority Data
Feb. 15, 2006 (JP) 2006-037874

(51) Int. Cl. G11B 5/147

(52) U.S. Cl. 360/126

(57) ABSTRACT

There is provided a thin-film magnetic head capable of locally projecting an element portion to a recording medium. A thin-film magnetic head includes an element portion including at least one of a reproducing element and a recording element; and a heat generating element projecting an element portion toward a recording medium by a thermal expansion due to heat generated by electrification of the head generating element, where the heat generating element passes through a plurality of layers constituting the thin-film magnetic head on an inner side in the height direction of the element portion.

This application claims the benefit of Japanese Patent Application No. 2006-037874 filed Feb. 15, 2006, which is hereby incorporated by reference.

### TECHNICAL FIELD

The present invention relates to a thin-film magnetic head which controls a levitation amount by locally projecting an element toward a recording medium by a thermal expansion.

### BACKGROUND

A thin-film magnetic head includes a generating element having a multilayer film exhibiting a magnetoresistance effect between a lower shield layer and an upper shield layer. The head reads magnetic information from a recording medium on the basis of a variation in resistance of the multilayer film. At least one of recording media has a pair of magnetic pole layers opposed to each other on a surface opposed to the recording medium with a magnetic gap layer interposed therebetween, and records the magnetic information by applying a magnetic field leaked from the magnetic gap layer to the recording medium. In a complex-type thin-film magnetic head having both the generating element and the recording element, the recording element is laminated on the generating element.

In the thin-film magnetic head, it is preferable to make a facing gap between an element portion including at least one of the generating element and the recording element and the recording medium, smaller to improve head characteristics (generating characteristic and recording characteristic). Therefore, in related art, it is suggested that the element portion projects to the recording medium by approximately several nm through thermal expansion by using a heat generating element which generates heat when supplied with electricity. The heat generating element is formed in a plane pattern parallel to the film surfaces of the layers constituting the thin-film magnetic head and is disposed between the layers. Specifically, the heat generating element is disposed on the bottom layer of a lower core layer or on the top layer of an upper core layer, between the lower core layer and the upper core layer, or in a surface protecting layer. The thin-film magnetic head having the heat generating element is disclosed in Patent Document 1, namely JP-A-2005-011413.

However, in related art, since projecting the element portion to the recording medium expands the periphery of the element portion by heat, it is difficult to control the element portion so as not to project too far toward the recording medium. Assuming that a projection amount in the periphery of the element portion is larger than the projection amount in the element portion, the periphery of the element portion is in contact with the recording medium earlier than the element portion. Therefore, there is a possibility that the recording and generating characteristics will be deteriorated and the recording medium will be damaged. Further, in related art, since thermal efficiency (the ratio between a heat amount supplied to the element portion and a total heat amount emitted by the heat generating element) is low and it is necessary to increase an electrical power supplied to the heat generating element, the efficiency becomes lower.

### SUMMARY

It is advantageous to provide a thin-film magnetic head capable of locally projecting an element portion toward a recording medium side.

In the thin-film magnetic head according to the invention, since the element portion and the periphery of the element portion are simultaneously heated, thermal efficiency is low. Accordingly, as described, the element portion is locally projected to the recording medium side by disposing a heat generating element perpendicularly to a plurality of layers constituting the thin-film magnetic head to improve the thermal efficiency.

That is, according to an aspect of the invention, a thin-film magnetic head includes an element portion including at least one of a reproducing element and a recording element, and a heat generating element projecting the element portion toward a recording medium by a thermal expansion by generating heat when supplied with electricity. The heat generating element passes through a plurality of layers constituting the thin-film magnetic head on an inner side in the height direction of the element portion.

The heat generating element is supplied with electricity in the laminating direction of the layers constituting the thin-film magnetic head. It is preferable that the heat generating element has a nonmagnetic insulating layer in the vicinity thereof.

In the thin-film magnetic head according to the invention, it is preferable that the reproducing element has a multilayer exhibiting a magnetoresistance effect, which is formed between a lower shield layer and an upper lower shield layer, and the heat generating element is provided from the same lamination height position as the multilayer film to the same lamination height position as the upper shield layer. Specifically, it is preferable that the recording element has a pair of magnetic pole layers vertically opposed to each other with a magnetic gap layer interposed therebetween and the heat generating element is provided from the same lamination position as at least one magnetic pole layer to the same lamination position as the other magnetic pole layer.

In the thin-film magnetic head according to the invention, since the heat generating element passes through the plurality of layers constituting the thin-film magnetic head and is provided on an inner side in the height direction of the element portion, heat generated from the heat generating element is efficiently supplied to the heat generating element. Therefore, it is possible to obtain the thin-film magnetic head capable of locally projecting the element portion to the recording medium.

### DRAWING

FIG. 1 is a fragmentary cross-sectional view of the laminated structure of a thin-film magnetic head as viewed from the center of an element according to a first embodiment of the invention.

FIG. 2 is a plan view of a heat generating element and a magnetic pole layer shown in FIG. 1 as viewed from an upper side.

FIG. 3 is a fragmentary cross-sectional view of the lamination structure of a thin-film magnetic head according to a second embodiment of the invention, as viewed from the center of an element.

FIG. 4 is a plan view showing the position relationship of a heat generating element and a magnetic pole layer shown in FIG. 3, as viewed from an upper side.

FIG. 5 is a fragmentary cross-sectional view of the lamination structure of a thin-film magnetic head according a third embodiment of the invention, as viewed from the center of an element.

FIG. 6 is a plan view showing the position relationship of a heat generating element and a magnetic pole layer shown in FIG. 5, as viewed from an upper side.

FIG. 7 is a cross-sectional view of a heat generating element according to an embodiment other than the first to third embodiments, as viewed from the opposed surface of a recording medium.

### DETAIL DESCRIPTION

Hereinafter, the present invention will be described with reference the drawings. In the drawings, an X direction represents a track width direction, a Y direction represent a height direction, and a Z direction the laminating direction of layers constituting the thin-film magnetic head and the movement direction of a recording medium.

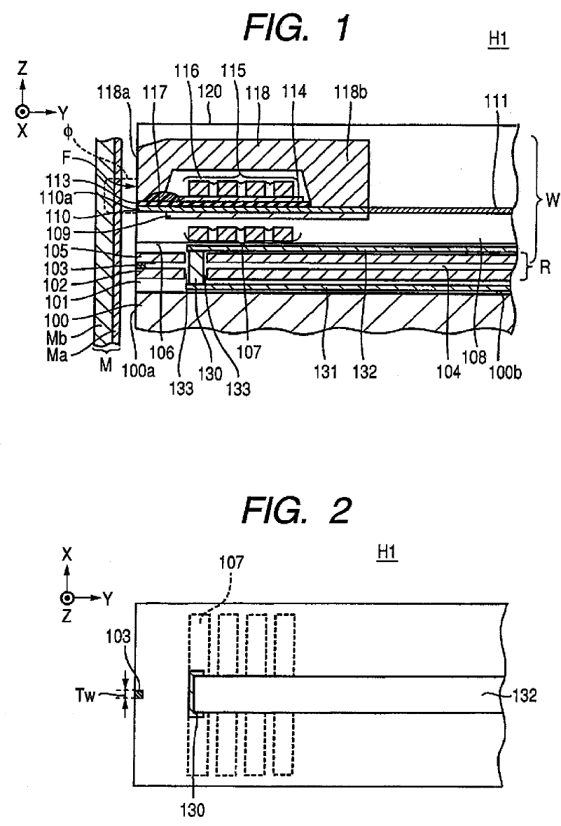

FIG. 1 is a fragmentary cross-sectional view of the lamination structure of a thin-film magnetic head H1 according to a first embodiment of the invention, as viewed from the center of an element.

FIG. 2 is a plan view of a thin-film magnetic head H1 as viewed from an upper side.

The thin-film magnetic head H1 is a vertical magnetic recording head having a reproducing portion R and a reproducing portion W formed by laminating thin films on the trailing end face 100b of a slider 100. The reproducing portion R reads magnetic information from a recording medium M by using a magnetoresistance effect, and the recording portion W performs a recording operation by applying a vertical magnetic field φ to the recording medium M and magnetizes the hard film Ma of the recording medium M perpendicularly.

The recording medium M includes the hard film Ma having high remanent magnetization thereon and a soft film Mb having high magnetic permeability on the inner side of the hard film Ma. The recording medium M has a disk shape and rotates on the center of the disk which serves as a rotation axis. The slider 100 is made of nonmagnetic materials, such as Al₂O₃ and SiO₂. A medium-opposed surface 100a opposite the recording medium M of the slider 100 is opposed to the recording medium M and when the recording medium M rotates, the slider 100 is levitated from the surface of the recording medium M by airflow thereon.

A protective layer 101 made of the nonmagnetic insulating materials, such as Al₂O₃ and SiO₂, is formed on the trailing end face 100b of the slider 100, and the reproducing portion R is formed on the protective layer 101. The reproducing portion R includes a lower shield layer 102, an upper shield layer 105, a gap insulating layer 104 interposed between the lower shield layer 102 and the upper shield layer 105, and a reproducing element 103 positioned in the gap insulating layer 104. The reproducing element 103 is the magnetoresistance effect element such as AMR, GMR, and TMR.

The recording portion W is laminated on the upper shield layer 105. The recording portion W, includes a plurality of lower coils 107 formed on the upper shield layer 105 with a coil insulating foundation layer 106 interposed therebetween, a main magnetic pole layer 110, a magnetic gap layer 113, a plurality of upper coils 115 formed on the magnetic gap layer 113 with the coil insulating foundation layer 114 interposed therebetween, and a sub-magnetic pole layer (return yoke layer) 118.

The lower coil 107 is formed of one or more kinds or two or more kinds of nonmagnetic metal materials selected from Au, Ag, Pt, Cu, Cr, Al, Ti, Ni, NiP, Mo, Pd, and Rh. Alternatively, the lower coil 107 may have a lamination structure in which the nonmagnetic metal materials are laminated. The lower coil insulating layer 108 is formed in the vicinity of the lower coil 107.

The main magnetic pole layer 110 and a sub-yoke layer 109 being in magnetic contact with the main magnetic pole layer 110, are formed on the lower coil insulating layer 108. The sub-yoke layer 109 made of the magnetic material having magnetic flux saturation density lower than the main magnetic pole layer 110 is formed directly below the main magnetic pole layer 110 and serves as a part of the main magnetic pole layer 110 magnetically. The top portions of the sub-yoke layer 109 and the lower coil insulating layer 108 are planarized. A coating foundation layer is formed on the planarized plane and the main magnetic pole layer 110 is formed on the coating foundation layer. The main magnetic pole layer 110 has a predetermined Y-direction length from an opposed surface F (hereinafter, referred to as ‘F’) to the recording medium. The X-direction size of a front end face 110a is defined as a recording track width Tw. The main magnetic pole layer 110 is coated with ferromagnetic materials having high saturation magnetic flux density, such as Ni—Fe, Co—Fe, and Ni—Fe—Co.

The magnetic gap layer 113 is formed on the main magnetic pole layer 110 and an insulating material layer 111 buried in the vicinity thereof (opposed sides of the X direction and the Y-direction rear of the main magnetic pole layer 110). The insulating material layer 111 is made of the nonmagnetic insulating materials, such as Al₂O₃ and SiO₂ and the magnetic gap layer 113 is made of the nonmagnetic materials such as Al₂O₃, SiO₂, Au, and Ru. A throat height determining layer 117 made of an inorganic material or an organic material, is formed on the magnetic gap layer 113 and in a position away from the opposed surface F by a predetermined distance. The throat height of the thin-film magnetic head H1 is defined by the distance from the opposed surface F to the throat height determining layer 117.

The upper coil 115 is formed of one or more kinds or two or more kinds of nonmagnetic metal materials selected from Au, Ag, Pt, Cu, Cr, Al, Ti, Ni, NiP, Mo. Pd, and Rh, similarly to the lower coil 107. Alternatively, the upper coil 115 may have the lamination structure in which the nonmagnetic metal materials are laminated. The upper coil insulating layer 116 is formed in the vicinity of the upper coil 115.

The X-direction end portions of the lower coil 107 and the upper coil 115 are in electrical contact with each other so as to be solenoid-like in shape. The shape of the coil layer (magnetic filed generating means) is not limited only to the solenoid-like shape.

The sub-magnetic pole layer 118 is formed of the ferromagnetic material, such as permalloy, from the upper coil insulating layer 116 through the magnetic gap layer 113. The sub-magnetic pole layer 118 has the front end face 118a exposed from the opposed surface F and is opposed to the main magnetic pole layer 110 on the opposed surface F by a gap. The rear end portion in the height direction of the sub-magnetic pole layer 11B is a contact portion 118b, which is in contact with the main magnetic pole layer 110. The sub-magnetic pole layer 118 is covered with a surface protecting layer 120.

The thin-film magnetic head H1 in its entire configuration includes a heat generating element 130 provided in a direction (Z direction shown in the drawing) perpendicular to the film surfaces of the layers constituting the thin-film magnetic head H1.

The heat generating element 130 is positioned on the inner side in the height direction of the element portion (reproducing element 103, main magnetic pole layer 110, magnetic gap layer 113, and sub-magnetic pole layer 118) and locally in the lower side of the coil layer. The heat generating element 130 shows a perpendicular pattern in which the heat generating element 130 passes through the plurality of layers constituting the thin-film magnetic head H1. In the first embodiment, the heat generating element 130 passes through the lower shield layer 102, the gap insulating layer 104, and the upper shield layer 105 from a same lamination height position as the protective layer 101 to a same layer position as the coil insulating foundation layer.

The heat generating element 130 is formed of NiFe, CuNi, or CuMn by a coating method or a sputtering deposition method. It is preferable to perform a surface planarizing operation (CMP processing) after the sputtering deposition in case that the heat generating element 130 is formed by the sputtering deposition method.

The planar size (cross-section area) of the heat generating element 130 is set in accordance with the planar size of the element portion. Specifically, the X-direction size of the heat generating element 130 is set to a size equal to or a bit larger than the track width in correspondence with the track width of the element portion.

The heat generating element 130 generates heat at the time of electrification in the Z direction shown in the drawing through a pair of magnetic pole layers 131 and 132. The pair of magnetic pole layers 131 and 132 are formed of nonmagnetic conductive material having low electrical resistance, such as Cu. The pair of magnetic pole layers 131 and 132 extend toward the inner side of the height direction as shown FIG. 2. The periphery (opposed sides in the X direction and opposed sides in the Y direction shown in the drawing) of the heat generating element 130 is covered with a nonmagnetic insulating layer 133. A magnetic pole layer 131 in contact with the bottom face of the heat generating element 130 is formed in the protective layer 101, and a magnetic pole layer 132 in contact with the top face of the heat generating element is formed in the coil insulating foundation layer 106. The insulating properties between the heat generating element 130 and the upper shield layer 102 and the upper shield layer 105 are obtained with the nonmagnetic insulating layer 133, the protective layer 101, and the coil insulating foundation layer 106 interposed therebetween. The nonmagnetic insulating layer 133 is formed of SiO₂, Al₂O₃, or a resist.

Heat generated from the heat generating element 130 is supplied from the heat generating element 130 to the opposed surface F side. As described above, the heat generating element 130 passes through the plurality of layers constituting the thin-film magnetic head H1, and is locally provided on the inner side in the height direction of the element portion and in the lower side of the lower coil 107. Accordingly, since the Z-direction cross-sectional area decreases, the expansion of the heat generated from the heat generating element 130 is suppressed. Therefore, it is difficult for the heat to be supplied in the vicinity of the element portion. That is, the vicinity of the element portion is concentratively heated, thereby projecting to the recording medium M. As described above, assuming that the element portion projects locally to the recording medium M, the facing gap between the element portion and the recording medium M is narrowed. Accordingly, it is possible to increase the output at the time of recording and reproducing operations, and keep the recording medium M in noncontact with the periphery of the element portion, thereby preventing the recording medium M from being damaged.

In the present embodiment, since the levitation amount of the thin-film magnetic head H1 is set to approximately 10 nm, and the maximum projecting amount in the vicinity of the element portion to be obtained when the heat generating element 130 is electrified is approximately 5 nm, it is possible to reduce the distance between the element portion and the recording medium M to approximately a half of the distance relative to the time when electricity to the heat generating element 130 is not supplied. It is possible to control the amount of projection the element portion in accordance with the heat generating temperature of the heat generating element 130, that is, the amount of current supplied to the heat generating element 130 or time.

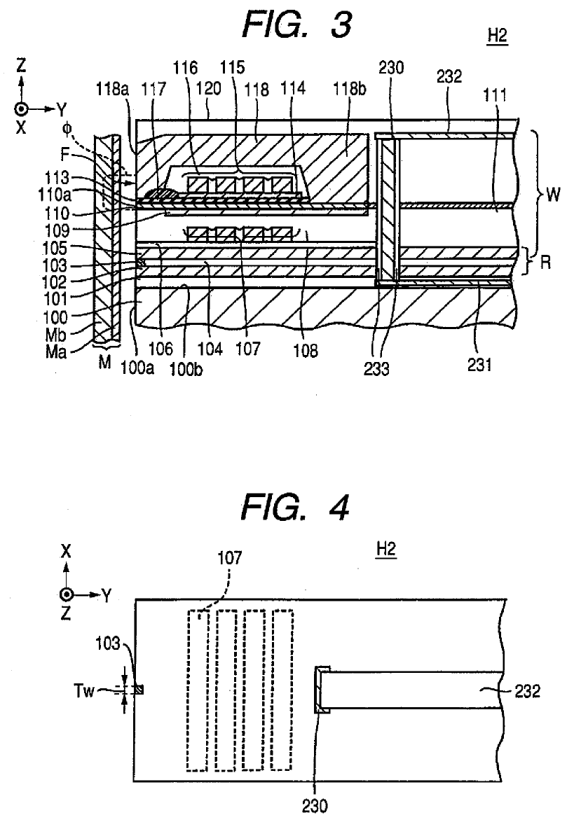

FIG. 3 is a fragmentary cross-sectional view of the lamination structure of a thin-film magnetic head H2 according to a second embodiment, as viewed from the center portion of an element. FIG. 4 is a plan view of a thin-film magnetic head H2 as viewed from an upper side.

In the thin-film magnetic head H2 according to the second embodiment, a heat generating element 230, which generates heat at the time of electrification is locally positioned on the inner side in the height direction of the sub-magnetic pole layer 118, and the heat generating element 230 passes through the lower shield layer 102, the gap insulating layer 104, the upper shield layer 105, the lower coil insulating layer 108, the insulating material layer 111, and the surface protecting layer 120 from the same lamination height position as the lower shield layer 102 to the same lamination height position as the sub-magnetic pole layer 118. The configuration in this embodiment is similar to the configuration in the first embodiment, except for the position of the heat generating element 230. In FIG. 3, the same reference numerals as used FIG. 1 are given to the same components as in the first embodiment.

The heat generating element 230 is electrified in the Z direction shown in the drawing through a pair of magnetic pole layers 231 and 232 in contact with the top face and the bottom face of the heat generating element 230. Similar to the first embodiment, the pair of magnetic pole layers 231 and 232 are formed of nonmagnetic conductive material having low electrical resistance, such as Cu. The pair of magnetic pole layers 231 and 232 extend toward the inner side of the height direction. The periphery (opposed sides in the X direction and opposed sides in the Y direction shown in the drawing) of the heat generating element 230 is covered with a nonmagnetic insulating layer 133. A magnetic pole layer 231 is buried in the protective layer 101 and a magnetic pole layer 232 is buried in the surface protecting layer 120. The insulating properties between the heat generating element 230 and the upper shield layer 102 and the upper shield layer 105 are obtained with the nonmagnetic insulating layer 133, the protective layer 101, and the surface protecting layer 120 interposed therebetween.

With respect to the second embodiment, the heat generating element 230 passes through the plurality of layers constituting the thin-film magnetic head H2 and is locally provided on the inner side in the height direction of the element portion. Accordingly, when the heat generating element 230 generates heat at the time of electrification, the vicinity of the element portion is concentratively heated. Therefore, the vicinity of the element portion projects locally toward the recording medium M.

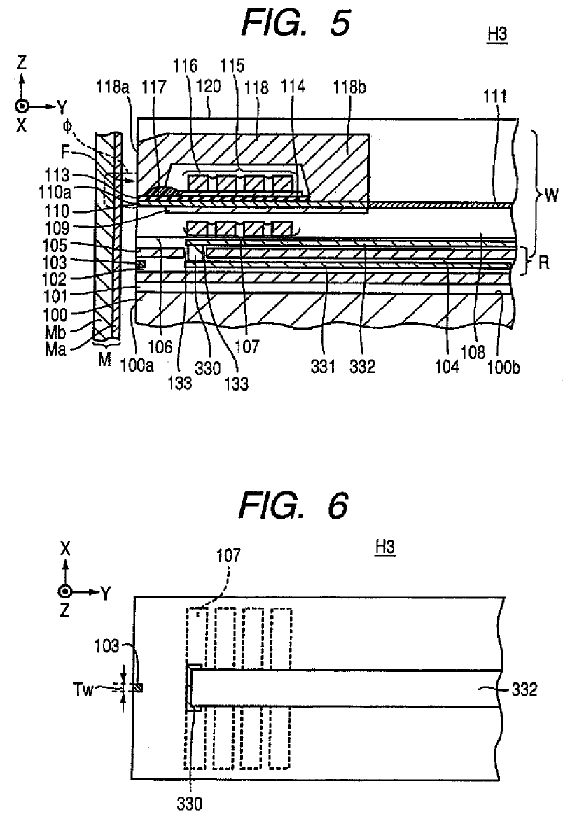

FIG. 5 is a cross-sectional view of the lamination structure of a thin-film magnetic head H3 according to a third embodiment of the invention, as viewed from the center of an element. FIG. 6 is a plan view of a thin-film magnetic head H3 as viewed from an upper side.

In the thin-film magnetic head H3 according to the third embodiment, a heat generating element 330 which generates heat at the time of electrification is positioned on the inner side in the height direction of the element portion and in the lower side of the lower coil 107, and the heat generating element 330 passes through the gap insulating layer 104, the upper shield layer 105, and the coil insulating foundation layer 106. The configuration in this embodiment is similar to the configuration in the first embodiment, except for the position where the heat generating element 330 is disposed. In FIGS. 5 and 6, the same reference numerals as FIG. 1 are given to the same components as in the first embodiment.

The heat generating element 330 is electrified in the Z direction shown in the drawing through a pair of magnetic pole layers 331 and 332 in contact with the top face and the bottom face of the heat generating element 330. Similar to the first embodiment, the pair of magnetic pole layers 331 and 332 are formed of nonmagnetic conductive material having low electrical resistance, such as Cu. The pair of magnetic pole layers 331 and 332 extend toward the inner side of the height direction. The periphery (opposed sides in the X direction and opposed sides in the Y direction shown in the drawing) of the heat generating element 330 is covered with a nonmagnetic insulating layer 133. A magnetic pole layer 331 is buried in the gap insulating layer 104, and a magnetic pole layer 332 is buried in the coil insulating foundation layer 106. The insulating properties between the heat generating element 330 and the upper shield layer 102 and the upper shield layer 105 are obtained with the nonmagnetic insulating layer 133, the gap insulating layer 104, and the coil insulating foundation layer 106 interposed therebetween.

According to the third embodiment, the heat generating element 330 passes through the plurality of layers constituting the thin-film magnetic head H3 and is locally provided on the inner side in the height direction of the element portion. Accordingly, when the heat generating element 330 generates heat at the time of electrification, the vicinity of the element portion is concentratively heated. Therefore, the vicinity of the element portion projects locally toward the recording medium M.

As described above, by the respective embodiments, since the heat generating element 130 (230, 330) pass through the plurality of layers constituting the thin-film magnetic head H1 (H2, H3), it is possible to narrow the Z-direction cross-section area (XY plane shown in the drawing) of the heat generating element 130 (230, 330) rather than in case that the heat generating element is formed in a plane pattern parallel to the film surfaces of the layers constituting the thin-film magnetic head H1 (H2, H3). As described above, assuming that the Z-direction cross-section area of the heat generating element 130 (230, 330) positioned on the inner side in the height direction of the element portion decreases, the heat generated from the heat generating element 130 (230, 330) is concentratively supplied and is not expanded to the vicinity of the element portion. That is, since the element portion projects locally toward the recording medium M, the facing gap between the element portion and the recording medium M is narrowed. Accordingly, it is possible to increase the output at the time of recording and reproducing operations. Then, it is possible to keep the recording medium M in noncontact with the periphery of the element portion, thereby preventing the recording medium M from being damaged. In addition, the heat of the heat generating element 130 (230, 330) is efficiently supplied to the element portion, thereby reducing an electrical power loss.

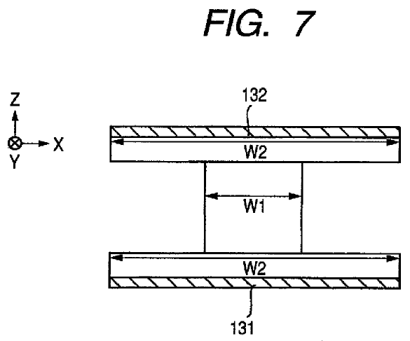

Further, in the respective embodiments, the heat generating element 130 (230, 330) is formed by setting the X-direction size to a constant value, however, the X-direction size of the heat generating element 130 (230, 330) may be different from the Z-direction size. For example, as shown in FIG. 7, in the heat generating element 430, the X-direction size W1 is equal to or a bit larger than the size in the element portion in the same height position as the element portion (reproducing element 103, main magnetic pole layer 110, magnetic gap layer 113, and sub-magnetic pole layer 118), and the size W2 in the track width direction is larger than the width of the element portion in the same lamination height position as the layers other than the element portion. As described above, in the case of forming the heat generating element in the multilayer structure, it is possible to project a desired portion of the thin-film magnetic head toward the recording medium side by varying the X-direction size of the layers.

The heat generating element may be provided in all interlayers as described in the first to third embodiments. Similarly, a pair of magnetic pole layers for supplying electricity to the heat generating element also may be provided in all interlayers. The direction in which the heat generating element is electrified is optional. For example, the pair of magnetic pole layers are provided on the layers of the heat generating element to supply the electricity to the heat generating element in the X direction shown in the drawing.

In addition, the pair of magnetic pole layers may be planar in shape. In the present embodiment, the pair of magnetic pole layers having a same shape are used, but a lower magnetic pole layer and an upper magnetic pole layer may have a different shape.

What is claimed is:

1. A thin-film magnetic head, comprising:
an element portion including at least one of a reproducing element and a recording element; and
a heat generating element configured to project the element portion toward a recording medium through thermal expansion due to heat generated by electrification of the heat generating element,
wherein the heat generating element extends through a plurality of layers constituting the thin-film magnetic head on an inner side in the height direction of the element portion.

2. The thin-film magnetic head according to claim 1, wherein the heat generating element is electrified along a direction of lamination of the layers constituting the thin-film magnetic head.

3. The thin-film magnetic head according to claim 1, wherein a nonmagnetic insulating layer surrounds the heat generating element.

4. The thin-film magnetic head according to claim 1, wherein the reproducing element has a multilayer exhibiting a magnetoresistance effect, the reproducing element formed between a lower shield layer and an upper lower shield layer, and the heat generating element extending from the same lamination height position in the multilayer film relative to the lower shield layer and upper shield layer.

5. The thin-film magnetic head according to claim 1, wherein the recording element has a pair of magnetic pole layers vertically opposed to each other with a magnetic gap layer interposed therebetween, and the heat generating element extending between the same lamination layers relative to both magnetic pole layers.
